(19) United States
(12) Patent Application Publication
(10) Pub. No.: US 2024/0044637 A1
(43) Pub. Date: Feb. 8, 2024

(54) Film Thickness Measurement Device and Method

(71) Applicant: NIPPON TELEGRAPH AND TELEPHONE CORPORATION, Tokyo (JP)

(72) Inventors: Yurina Tanaka, Tokyo (JP); Azusa Ishii, Tokyo (JP); Soichi Oka, Tokyo (JP)

(21) Appl. No.: 18/252,293

(22) PCT Filed: Nov. 11, 2020
(86) PCT No.: PCT/JP2020/042032

§ 371 Date: May 9, 2023

(51) Int. Cl. G01B 11/06; G06T 7/60

(52) U.S. Cl. CPC G01B 11/06; G06T 7/60; G06T 2207/10101; G06T 2207/30184

(57) ABSTRACT

A storage unit stores a reference image. A camera captures a film thickness measuring portion of a coating film to be measured. A determination circuit determines whether or not an image captured by the camera and the reference image match. A film thickness meter measures a film thickness of the coating film at the film thickness measuring portion in a case where the determination circuit determines that the image and the reference image match. The film thickness meter measures a film thickness of the coating film by, for example, optical coherence tomography.

### CROSS-REFERENCE TO RELATED APPLICATIONS

This application is a national phase entry of PCT Application No. PCT/JP2020/042032, filed on Nov. 11, 2020, which application is hereby incorporated herein by reference.

### TECHNICAL FIELD

The present invention relates to a film thickness measurement apparatus and a film thickness measurement method of measuring a film thickness of a coating film.

### BACKGROUND

A paint has a function of preventing an object to be coated from being deteriorated by corrosion, ultraviolet rays, weathering, or the like, and this function is referred to as “protection”. Specifically, a coating film is coated on a base material such as metal, concrete, wood, plastic, or the like of automobiles, ships, aircraft, bridges, houses, buildings, home electric appliances, and the like, and the coating film protects the base material from deterioration such as corrosion by shielding the base material from oxygen, water, chloride ions, and the like which are deterioration factors of the base material (Non Patent Literature 1). However, aging deterioration of the coating film itself also occurs due to ultraviolet rays or water, and the protection function from the coating film gradually decreases. For this reason, in infrastructure facilities such as steel towers and bridges, inspection work for measuring a thickness of a coating film by using a film thickness meter and confirming that a film thickness sufficient to protect a base material remains is performed. A measurement result of the film thickness is one important index of maintenance such as recoating.

### CITATION LIST

### Non Patent Literature

Non Patent Literature 1: “Wakaru!Tsukaeru!Toryo Numon”, written by Toshikatsu KOBAYASHI, published by NIKKAN KOGYO SHIMBUN, LTD., first printing, 2018.

### SUMMARY

### Technical Problem

On the other hand, in order to accurately evaluate a temporal change in the thickness of a coating film, it is important to always measure a film thickness in the same region. However, in infrastructure facilities, a mark for identification or the like may not be attached to a measurement portion, and a film thickness may not always be measured in the same region.

Embodiments of the present invention have been made to solve the above problems, and an object of embodiments of the present invention is to make it possible to always measure a film thickness in the same region.

### Solution to Problem

According to embodiments of the present invention, there is provided a film thickness measurement apparatus including: a storage unit that stores a reference image; a camera that captures a film thickness measuring portion of a coating film to be measured; a determination circuit that determines whether or not an image captured by the camera and the reference image match; and a film thickness meter that measures a film thickness of the coating film at the film thickness measuring portion in a case where the determination circuit determines that the image and the reference image match.

Further, according to embodiments of the present invention, there is provided a film thickness measurement method including: a first step of capturing an image of a film thickness measuring portion of a coating film to be measured; a second step of determining whether or not an image obtained by capturing the film thickness measuring portion matches a reference image; and a third step of measuring a film thickness of the coating film at the film thickness measuring portion in a case where it is determined that the image and the reference image match.

### Advantageous Effects of Embodiments of the Invention

As described above, according to embodiments of the present invention, in a case where the image of the film thickness measuring portion of the coating film captured to be measured matches the reference image, a film thickness is measured. Thus, the film thickness can always be measured in the same region.

### BRIEF DESCRIPTION OF THE DRAWINGS

FIG. 1 is a configuration diagram illustrating a configuration of a film thickness measurement apparatus according to an embodiment of the present invention.

FIG. 2 is a configuration diagram illustrating a configuration of a film thickness meter using optical coherence tomography.

FIG. 3 is a flowchart for explaining a film thickness measurement method according to an embodiment of the present invention

### DETAILED DESCRIPTION OF ILLUSTRATIVE EMBODIMENTS

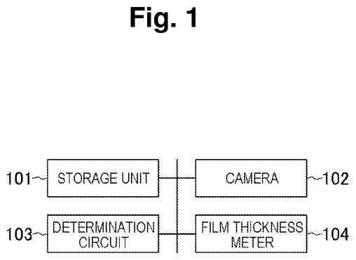

Hereinafter, a film thickness measurement apparatus according to an embodiment of the present invention will be described with reference to FIG. 1. The film thickness measurement apparatus includes a storage unit 101, a camera 102, a determination circuit 103, and a film thickness meter 104.

The storage unit 101 stores a reference image. The camera 102 captures an image of a film thickness measuring portion of a coating film to be measured. The reference image is acquired by the camera 102 capturing an image of a film thickness measuring portion of a coating film to be measured in advance. For example, immediately after a coating film that is a measurement target is formed, an image is obtained by capturing a state of the coating film at a portion where is set to be measured by the camera 102, and the obtained image can be used as the reference image.

The determination circuit 103 determines whether or not an image captured by the camera 102 matches the reference image. For example, it can be determined whether or not an image captured by the camera 102 matches the reference image by using a pattern matching technique well known as an image authentication technique or the like. The determination circuit 103 can be configured with, for example, a computer device including a central processing unit (CPU), a main storage device, and an external storage device. In a case where the CPU operates by a program developed in the main storage device (executes the program), pattern matching is implemented.

In a case where the determination circuit 103 determines that the image matches the reference image, the film thickness meter 104 measures a film thickness of the coating film at a film thickness measuring portion. The film thickness meter 104 measures a film thickness of the coating film by using, for example, optical coherence tomography. Note that the film thickness meter 104 can also be an electromagnetic type (electromagnetic induction type) or an eddy current type of a film thickness meter. In an electromagnetic type (electromagnetic induction type) or an eddy current type of a film thickness meter, it is important to vertically press a measurement probe against the measurement target in order to obtain measurement accuracy. In addition, an electromagnetic type (electromagnetic induction type) or an eddy current type of a film thickness meter can measure only a portion against which a measurement probe is pressed (Japanese Patent No. 6222396).

On the other hand, in a large facility such as a steel tower or a bridge, in many cases, it is not easy to vertically press a measurement probe against a measurement portion. In addition, in this type of a coating film, irregularities due to brush marks, pigments, or the like may be larger than irregularities due to wear of a film thickness. Further, film thickness measurement by an electromagnetic type or an eddy current type of a film thickness meter may have a large variation depending on a measurement portion. In film thickness measurement in such a case, generally, measurement is repeatedly performed at a plurality of portions, and an average value is obtained. In this case, an operation time is required, and it may be difficult to accurately evaluate a film thickness with a practical number of measurements.

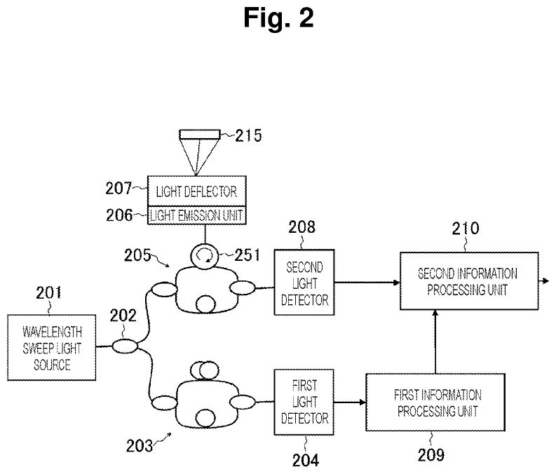

On the other hand, according to film thickness measurement using optical coherence tomography, it is possible to obtain multi-point film thickness data in a short time without repeatedly performing manual measurement. For example, as illustrated in FIG. 2, a film thickness meter using optical coherence tomography first includes a wavelength sweep light source 201 having a center wavelength of 10 μm to 3 mm, an optical branch coupler 202 that branches light from the wavelength sweep light source 201 into two, a reference interferometer 203 that uses light branched by the optical branch coupler 202, and a first light detector 204 that receives light of the reference interferometer 203.

In addition, the film thickness meter includes a measurement interferometer 205 that uses light branched by the optical branch coupler 202, a light deflector 207 that is attached to a light emission unit 206 of the measurement interferometer 205, a second light detector 208 that receives light of the measurement interferometer 205, a first information processing unit 209 that configures a sampling point using an interference signal from the reference interferometer 203, and a second information processing unit 210 that analyzes an interference signal of the measurement interferometer 205 based on data from the first information processing unit 209.

The wavelength sweep light source 201 is a light source of which an output wavelength changes with periodicity. The reference interferometer 203 is a Mach-Zehnder interferometer. The measurement interferometer 205 is a Mach-Zehnder interferometer, and includes an optical circulator 251.

The light which is output from the wavelength sweep light source 201 is branched into two using a coupler on an incidence side of the Mach-Zehnder interferometer, and the branched light is guided by one arm for measurement and the other arm for reference. In addition, an optical circulator 251 is provided on one arm of the measurement interferometer 205, and a light emission unit 206 is optically connected to the optical circulator 251. The light deflector 207 performs scanning with the light emitted from the light emission unit 206. A sample 215 of which a film thickness is to be measured is provided at an irradiation destination of the light with which the light deflector 207 performs scanning.

The sample 215 is irradiated with the light with which scanning is performed, and the light is reflected by the sample 215. The reflected light returns to one arm by the optical circulator 251 via the light emission unit 206. An optical path length of one arm for the measurement is matched with an optical path length of the other arm for reference. The light guided by one arm and the light guided by the other arm are multiplexed and interfered by a coupler on an emission side of the Mach-Zehnder interferometer. The interference of light is received by the second light detector 208, and photoelectric conversion of the interfered light is performed. An interference signal obtained by performing photoelectric conversion in this manner is subjected to frequency analysis by the second information processing unit 210. Thereby, frequency information according to a measurement distance is obtained, and a measurement distance is obtained.

For example, it is assumed that the optical path length of each arm is Zref. In a case where the sample 215 is provided at a position away from the light emission unit of one arm by Z, it is possible to measure a distance of an optical path length difference 2Z (light reciprocation). In a case of a coating film coated on a base material such as metal, reflected light from a surface of the coating film and reflected light from the base material can be acquired. In a case where it is assumed that a film thickness of the coating film is δd, information of 2δd can be obtained.

The interference signal obtained by performing photoelectric conversion by the first light detector 204 is obtained at equal time intervals. On the other hand, in frequency analysis, in a case where a signal is obtained at equal wavenumber intervals, a frequency resolution can be improved, and accurate distance measurement can be performed.

In order to obtain a signal at equal wavenumber intervals, a sweep frequency of the wavelength sweep light source 201 itself is at equal time intervals or a waveform shaping technique is used in frequency analysis. The waveform shaping technique can be performed by acquiring a temporal change of a wavenumber from Fourier transform of the interference signal (refer to JP 2016-205999A). The reference interferometer 203 is an interferometer required for performing the waveform shaping. By providing the reference interferometer 203 separately from the measurement interferometer 205, an interference signal required for the waveform shaping can be obtained at the same time when obtaining a signal for film thickness measurement.

As described in Reference Document 1, a distance resolution is improved by setting a sampling point of the interference signal in a frequency-linear manner. For this reason, in the film thickness meter, in order to set sampling intervals of the interference signal from equal time intervals to equal wavenumber intervals, the first information processing unit 209 is provided. Thereby, the distance resolution is improved.

The first information processing unit 209 performs Fourier transform on the interference signal of the reference interferometer 203, replaces a negative frequency component with o, and performs inverse Fourier transform. Thereby, an analysis signal is generated. From a time characteristic of a deflection angle θ of the analysis signal, a time (sampling time) when the deflection angle θ is at equal intervals is obtained. Normally, the sampling point is set at equal time intervals. On the other hand, by performing sampling (resampling) at equal phase (deflection angle θ) intervals, a resolution of a beat frequency after Fourier transform can be improved.

The second information processing unit 210 performs resampling of the interference signal according to the sampling time obtained by the first information processing unit 209, and performs Fourier transform on the resampled interference signal. Thereby, a center value of a beat frequency is obtained. The second information processing unit 210 obtains a film thickness of the sample 215 from the sweep frequency of the wavelength sweep light source 201 and the beat frequency described above.

In addition, by acquiring data on a two-dimensional plane by using the light deflector 207, it is possible to more accurately detect a wear state of the coating film. As the light deflector 207, a mechanically-driven-type light deflector such as a galvano mirror, an electro-optical-type light deflector using a KTN crystal or the like, or an acousto-optical-type light deflector may be used. For example, in a case where a galvano mirror is used, scanning of approximately ±10 degrees is allowed. Thus, in a case where a film thickness of the coating film is measured at a position from 10 cm away, a film thickness of the coating film in a range of 3×3 cm can be measured.

Here, a distance resolution δz by optical coherence tomography is represented by the following Equation (Reference Document 2).

$$δ z = \frac{2 ln 2}{π} \frac{{λ}_{c}^{2}}{n Δ λ} \qquad [ Equation 1 ]$$

In the Equation, λc indicates a center wavelength of the light source, Δλ indicates a wavelength half-value width of the light source, and n indicates a refractive index of a material. According to the Equation, for example, in a case where the center wavelength is 65 μm and the half-value width is 70 μm, the distance resolution δz is 27 μm. Therefore, it is possible to measure the film thickness at intervals of 27 μm.

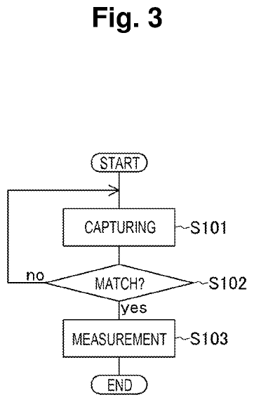

Next, a film thickness measurement method according to an embodiment of the present invention will be described with reference to a flowchart of FIG. 3.

First, in a first step S101, the camera 102 captures an image of a film thickness measuring portion of a coating film to be measured. Next, in a second step S102, the determination circuit 103 determines whether or not the image obtained by capturing the film thickness measuring portion by the camera 102 matches the reference image stored in the storage unit 101. In a case where it is determined that the captured image matches the reference image by the determination (yes in second step S102), in a third step S103, the film thickness meter 104 measures a film thickness of the coating film at the film thickness measuring portion. Here, for example, a film thickness of the coating film is measured using optical coherence tomography. By using the film thickness measured in this manner, it is possible to more accurately evaluate aging deterioration of the coating film.

As described above, according to embodiments of the present invention, in a case where the image of the film thickness measuring portion of the coating film to be measured matches the reference image, a film thickness is measured. Thus, the film thickness can be always measured in the same region. In addition, by measuring a film thickness of the coating film by using optical coherence tomography, multipoint measurement by scanning can be performed. Thus, an influence by a variation in film thickness measurement can be reduced. In the film thickness measurement using optical coherence tomography, it is possible to measure film thicknesses on a plane and average the measured film thicknesses. Thus, a variation depending on the measurement portion is not likely to occur, and it is possible to prevent a variation in measurement results caused by irregularities due to brush marks and pigments on the surface of the coating film and irregularities due to the base material itself. Therefore, in a case where the technique is used for maintenance of infrastructure facilities or the like, it is possible to optimize a recoating time of the coating film in consideration of a residual film thickness of the coating film.

In general, a residual film thickness cannot be accurately evaluated. For this reason, after the protection function of the coating film is deteriorated due to a reduction of the film thickness and deterioration such as generation of rust on the base material is confirmed, maintenance such as recoating is often performed. On the other hand, according to embodiments of the present invention, the film thickness of the same region can be accurately measured. Thus, it is possible to accurately evaluate wear of the film thickness and calculate a wear speed. Therefore, by performing maintenance such as recoating in a period for which the film thickness at which the protection function of the coating film is sufficiently secured is remained, it is possible to perform preventive maintenance without damage of the base material. In addition, in a case where the method is used for a test piece or the like, it is possible to improve efficiency and accuracy in product performance evaluation.

Note that the present invention is not limited to the embodiment described above, and it is obvious that many modifications and combinations can be implemented by those skilled in the art within the technical spirit of the present invention.

### REFERENCE DOCUMENT

[Reference Document 1] Y. Yasuno et al., “Three-dimensional and high-speed swept-source optical coherence tomography for in vivo investigation of human anterior eye segments”, Optics Express, vol. 13, no. 26, pp. 10652-10664, 2005.

[Reference Document 2] S. H. Yun et al., “High-speed optical frequency-domain imaging”, Optics Express, vol. 11, no. 22, pp. 2953-2963, 2003.

### REFERENCE SIGNS LIST

101 storage unit
102 camera
103 determination circuit
104 film thickness meter.

1-4. (canceled)

5. A film thickness measurement method comprising:
capturing an image of a part of a coating film;
determining whether or not the image of the part of the coating film matches a reference image; and
measuring a film thickness of the coating film at the part of the coating film in response to determining that the image and the reference image match.

6. The film thickness measurement method according to claim 5, wherein the film thickness of the coating film is measured through optical coherence tomography.

7. The film thickness measurement method according to claim 6, wherein film thickness meter includes:
a wavelength sweep light source;
an optical branch coupler configured to branch light from the wavelength sweep light source into two;
a reference interferometer configured to use first light branched by the optical branch coupler; and
a first light detector configured to receive light from the reference interferometer.

8. The film thickness measurement method according to claim 7, wherein film thickness meter further includes:
a measurement interferometer configured to use second light branched by the optical branch coupler;
a light deflector attached to a light emitter of the measurement interferometer;
a second light detector configured to receive light from the measurement interferometer;
a first information processor configured to configure a sampling point using an interference signal from the reference interferometer; and
a second information processor configured to analyze an interference signal of the measurement interferometer based on data from the first information processor.

9. The film thickness measurement method according to claim 5, wherein the reference image is an image the part of the coating film taken prior to capturing the image of the part of the coating film.

10. The film thickness measurement method according to claim 9, wherein the reference image is an image the part of the coating film taken immediately after applying the coating film.

11. A film thickness measurement apparatus comprising:
a storage device configured to store a reference image;
a camera configured to capture an image of a part of a coating film;
a determination circuit configured to determine whether or not an image captured by the camera and the reference image match; and
a film thickness meter configured to measure a film thickness of the coating film at the part of the coating film in response to the determination circuit determining that the image and the reference image match.

12. The film thickness measurement apparatus according to claim 11, wherein the film thickness meter is configured to measure the film thickness of the coating film through optical coherence tomography.

13. The film thickness measurement apparatus according to claim 12, wherein film thickness meter includes:
a wavelength sweep light source;
an optical branch coupler configured to branch light from the wavelength sweep light source into two;
a reference interferometer configured to use first light branched by the optical branch coupler; and
a first light detector configured to receive light from the reference interferometer.

14. The film thickness measurement apparatus according to claim 13, wherein film thickness meter further includes:
a measurement interferometer configured to use second light branched by the optical branch coupler;
a light deflector attached to a light emitter of the measurement interferometer;
a second light detector configured to receive light from the measurement interferometer;
a first information processor configured to configure a sampling point using an interference signal from the reference interferometer; and
a second information processor configured to analyze an interference signal of the measurement interferometer based on data from the first information processor.

15. The film thickness measurement apparatus according to claim 11, wherein the reference image is an image the part of the coating film taken prior to capturing the image of the part of the coating film.

16. The film thickness measurement apparatus according to claim 15, wherein the reference image is an image the part of the coating film taken immediately after applying the coating film.
